(19) United States
(12) Patent Application Publication
(10) Pub. No.: US 2009/0262780 A1
(43) Pub. Date: Oct. 22, 2009

(54) Device for Measuring and Analyzing Melt in Metallurgical Vessels

(76) Inventors: Norbert Uebber, Langenfeld (DE); Udo Falkenreck, Bochum (DE); Jens Kempken, Dusseldorf (DE)

Correspondence Address: ABELMAN, FRAYNE & SCHWAB, 666 THIRD AVENUE, 10TH FLOOR, NEW YORK, NY, 10017, US

(21) Appl. No.: 11/794,631

(22) PCT Filed: Dec. 23, 2005
(86) PCT No.: PCT/EP05/13993

§ 371 Date: Jun. 29, 2007

(51) Int. Cl. G01K 13/00

(52) U.S. Cl. 374/139; 374/E13.001

(57) ABSTRACT

A device for measuring temperature and analyzing melt in metallurgical vessels with a channel pipe KN arranged on a side wall of a vessel KV, extending with a lower end thereof into this wall, and ending with an upper open end thereof above the vessel KV for taking a melt probe, which has, above an opening, an air inlet with an associated inlet/outlet valve VT and above it, a rotary valve DS that opens a cross-section of the channel pipe KN for introducing measuring probes, laser, or temperature feeler, and closes it.

The present invention relates to a device for measuring temperatures and analyzing melts in metallurgical vessels. Numerous different embodiments of this type of the device are well known. A common feature of these devices consists in that in a wall of a melt-receiving vessel, openings piercing the same are provided through which gas for retaining and cooling of molten goods is applied and which permit to analyze melt with aid of lasers or other apparatuses and to measure its temperature.

Because of the arrangement of the analyzing apparatuses in vicinity of a nozzle outlet, heat and the produced dust make the handling of them during operation very difficult and, therefore, transitional devices in form of tubular systems with mirrors or light conductors were developed. According to WO 03 081287, an optical recorder is arranged above a plane of the melt of the metallurgical vessel and which is connected by an optical fiber cable with lenses of a laser detector that can be arbitrarily arranged remotely from the molten goods. WO 2004 001 394 and WO 02 27301 suggest to form bores in the side walls of the metallurgical vessels in which the melt is held back by application of gas, and a probe section of a molten material is detected by hinged, arranged outside of the metallurgical vessel, mirror devices of laser beams which are connected with likewise arranged outside, evaluating devices.

These devices require large constructional and servicing expenses. The object of the invention is to prevent such expenses and to provide a device that would consist of few components, could be easily mounted and easily served. The invention proceeds from the suggestion of DE 44 43 407 to provide a device for producing plasma out of the molten material and having a pipe with an end immersed in the molten material, a device for optical detection of the radiation emission of the plasma, and also a spectroscopical evaluation device, and suggests to arrange such a pipe on the metallurgical vessel in form of a channel with a fire-resistant lining and inclined to the surface of the molten material, wherein the lower end of the channel opens into the side wall of the metallurgical vessel, and its upper end lies above the plane of the molten material bath, and in the region above the plane of the molten material bath and the upper end of the channel, a gas inlet with an associated inlet-outlet valve and above it, a rotary valve that opens and closes the channel cross-section, are provided.

This device is so operated according to the invention that with a closed rotary valve and an opened inlet valve, a compressed gas is applied to the channel, and the molten material that penetrated in the channel through its lower end, and its slag component are pushed back from the channel. Finally, the gas pressure is removed, and a slag-free molten material can flow into the channel. With an opened rotary valve, there exists a possibility to push measuring probes, laser, or temperature feeler through the rotary valve opening and through the channel. This process can be repeated by corresponding closing and opening of the valve and the rotary valve. With the use of a converter as a metallurgical vessel, it is expedient to arrange the channel with its upper opening inclined toward the tapping side so that in the tapping position of the converter, the plane of the molten material is beneath the channel opening and in the subsequent deslagging position, the lower opening of the channel lies on the converter above the slag line and insures in a simple way, that the molten material or the slag residue cannot exit from the channel as a result of tilting movement. With the inventive device and its use, a reliable access to the molten material plane is provided, with a small need in gas to keep the opening free, and no gas turbulence and melt mixtures are produced at the measurement point. The access channel to the molten material can be inexpensively cleaned, if needed. No mirror for laser and spectrometer and no optical glass in the beam path are needed. The height of the molten material plane can be determined with contact-free distance measuring apparatuses. Large cross-sections of the access channel permit to use microwaves, which are produced with a laser, for an energetic excitation of the atoms of the molten material.

The invention will be explained in detail with reference to the drawings.

The drawings show:

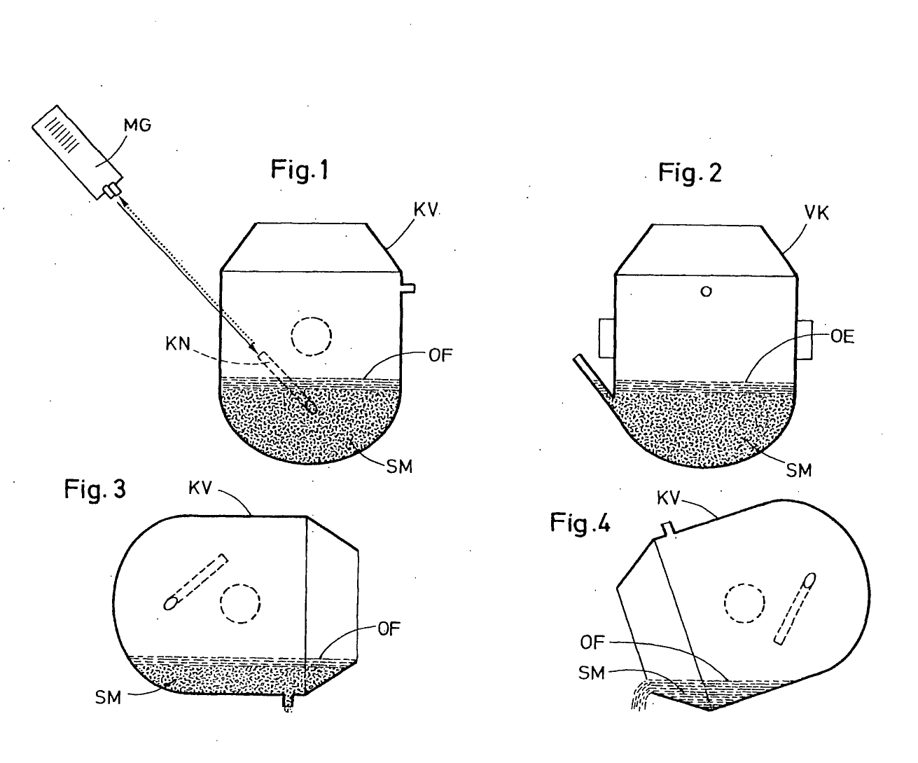

FIG. 1 a schematic view of a converter seen in a direction of the tilting axis;

FIG. 2 side view of FIG. 1;

FIG. 3 the converter according to FIG. 1 in a tapping position;

FIG. 4 the converter according to FIG. 1 in a deslagging position; and

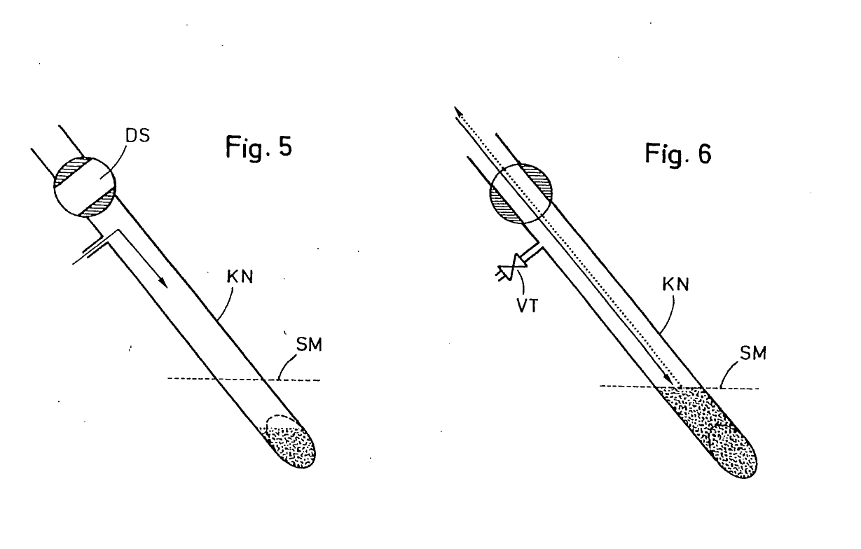

FIG. 5 and FIG. 6 a schematic side cross-sectional view of the channel.

As shown in FIGS. 1 through 4, a channel KN in form of a pipe is arranged on a side wall of a converter KV at an angle to a surface OF of a smelting bath SM and opens into the side wall of the converter KV. As shown in FIGS. 5 and 6, the channel KN has a valve VT opening outwardly, above its opening, and above it, a rotary valve DS with which a cross-section can be completely open and closed.

According to FIGS. 5 and 6, the channel KN finds itself in positions of the converter KV shown in FIGS. 1 and 2. As shown in FIG. 5, after closing the rotary valve DS and delivery of a compressed gas through the valve VT into the channel KN, the melt is pushed back into the converter KV. Finally, after a reduction of the gas pressure over the valve VT, the slag-free melt flows back into the channel KN. Then, the melt surface SM can be analyzed by measuring instruments MG and probes (FIG. 1), e.g., by plasma excitation with the aid of a laser and a subsequent spectroscopy of the emitted plasma radiation. As shown in FIGS. 1 through 4, the channel KN is arranged with a tilt of the converter KV toward the tapping side, so that the lower opening of the channel KN is always above the melt surface at both tapping position and the deslagging position of the converter KV.

### LIST OF REFERENCE SIGNS

KV Converter

OF Melt surface

KN Channel pipe

SM Melt

VT Valve

DS Rotary valve

MD Opening

MG Measuring instrument

1. A device for measuring temperature and analyzing melt in metallurgical vessels,
characterized by
a channel pipe KN arranged on a side wall of a vessel KV, extending with a lower end thereof into this wall, and ending with an upper open end thereof above the vessel KV, which has, above an opening, an air inlet with an associated inlet/outlet valve VT and above it, a rotary valve DS that opens and closes a cross-section of the channel pipe KN.

2. A device according to claim 1 with a vessel pivotable about a horizontal axis,
characterized in that
the channel KN is arranged with inclination toward a melt surface.

3. A device according to claim 2,
characterized in that
the opening MD of the channel KN in the side wall of the vessel KV is so inclined that it lies above the melt surface in tapping and deslagging position of the vessel KV.
